(19) United States
(12) Patent Application Publication
(10) Pub. No.: US 2026/0220853 A1
(43) Pub. Date: Jul. 30, 2026

(54) SYSTEM AND METHOD FOR INTEGRATING VISUAL ELEMENTS IN IMAGE AND VIDEO

(71) Applicant: Idomoo LTD, Raanana (IL)

(72) Inventors: Danny KALISH, Raanana (IL); Ariel Marcos Isaac NEHMAD, Ramat Gan (IL); Joris VAN LIENEN, Raanana (IL)

(21) Appl. No.: 19/462,180

(22) Filed: Jan. 28, 2026

Related U.S. Application Data
(60) Provisional application No. 63/750,543, filed on Jan. 28, 2025.

(51) Int. Cl. G06T 11/60; G06V 10/70

(52) U.S. Cl. CPC G06T 11/60; G06V 10/70

(57) ABSTRACT

The present invention provides A method for integrating visual elements in image and video, perform the steps of:
producing a heat map for scoring positive placement areas for at least one first visual element within the context of a second visual element;
producing an attention map for scoring negative placement areas for at least one first visual element within the context of a second visual element, wherein the attention map identifies important regions of the image indicating where not to place the visual element;
using distance fields to score placement of visual elements;
scoring in accordance with relevant design rules to determine and score positive and negative areas derived from the heat map, attention map and distance field;
generating multiple layout permutations of the elements, to be evaluated against the scoring to select the best possible placement, layout and style.

### BACKGROUND

### Technical Field

The present invention relates generally to integrating text, image and video, more specifically selecting the optimal area for placing visual elements in the context of a composition.

### Background Art

The creation of visually appealing compositions that integrate text, logos, icons, and other visual elements with images and video frames is a fundamental requirement in digital media production, advertising, and content creation. Traditionally, this process has relied heavily on skilled graphic designers who manually determine appropriate placement locations for overlaid elements, considering factors such as visual balance, readability, and avoiding obstruction of important image content.

Existing automated approaches to visual element placement typically employ simplistic rule-based heuristics, such as placing text in predetermined corner regions, areas of uniform color, or regions with low contrast. These conventional methods often produce suboptimal results because they fail to comprehensively analyze the semantic content of the underlying image. As a result, text or other visual elements may obscure important subjects, appear in visually cluttered areas, or create compositions that lack aesthetic appeal.

Some prior art systems utilize basic image analysis techniques such as edge detection or color uniformity analysis to identify potential placement regions. However, these approaches do not adequately distinguish between regions that are merely empty and regions that are aesthetically suitable for element placement. Furthermore, such systems typically do not consider the interplay between positive placement areas (where elements should go) and negative areas (where important content should remain visible).

Recent advances in deep learning and computer vision have enabled more sophisticated image understanding, including salient object detection and semantic segmentation. However, the application of these technologies to the specific problem of visual element placement optimization remains limited. Existing solutions do not provide an integrated approach that simultaneously considers: identifying aesthetically suitable placement regions using learned models; protecting important visual content from obstruction; maintaining appropriate spatial relationships and distances from both content and image boundaries; and evaluating multiple layout configurations against established design composition rules.

There remains a need in the art for an automated system that can intelligently determine optimal placement of visual elements within images and video frames, achieving results comparable to professional manual design while enabling scalable, efficient content production workflows.

### SUMMARY

The present invention provides A method for integrating visual elements in image and video, implemented by one or more processors operatively coupled to a non-transitory computer readable storage device, on which are stored modules of instruction code that when executed cause the one or more processors to perform the steps of:
producing a heat map for scoring positive placement areas for at least one first visual element within the context of a second visual element, wherein the visual element is at least one of image or video frame;
producing an attention map for scoring negative placement areas for at least one first visual element within the context of a second visual element, wherein the attention map identifies important regions of the image indicating where not to place the visual element;
using distance fields to score placement of visual elements, wherein the placement optimization is achieved by minimizing obscuring important parts of the image or video frame while maintaining maximum distance from all important parts; wherein the distance field depth measures the distance for every pixel from the nearest pixel in the attention map or the image margins, wherein for each pixel, a deeper score indicates that the pixel is further away from key objects, and highest scores are set for the emptiest areas
scoring in accordance with relevant design rules to determine and score positive and negative areas derived from the heat map, attention map and distance field;
generating multiple layout permutations of the elements, which are then evaluated against all the scoring criteria to select the best possible placement, layout and style; and
wherein the heat map and the attention map are produced automatically using training data by AI models.

According to some embodiments of the present invention the distance field is derived from the attention map, to evaluate whether elements need to be positioned further from important objects in the image and to identify the areas where the placement of the elements would create the best balance within the composition.

According to some embodiments of the present invention the method further comprising the step of clustering: using the heat map (positive areas) and attention map and distance field (negative areas), wherein a clustering algorithm is performed to evaluate one or many areas where the placement of elements would yield the most positive results.

According to some embodiments of the present invention the heat map neural network is trained to recognize optimal locations for visual element placement by analyzing spaces, areas, or objects within an image, and identifies regions that are positively suited for placing the visual elements, ensuring that the elements integrate seamlessly with the image.

According to some embodiments of the present invention the training process utilizes in-painted images and heat maps as inputs, wherein the heat maps are generated using input received from either OCR utilizing bounding box coordinates or text segmentation module to produce a ground truth for training.

According to some embodiments of the present invention the design rules evaluate features including at least one of: color, shape, alignment, layout, font selection, and the use of positive and negative spaces in the placement of visual elements.

According to some embodiments of the present invention for each layout permutation and cluster, a scoring process is applied comprising: scoring the best overlap between each cluster and layout of elements, considering the heat map, distance field, and a dense element representation, in accordance with layout composition rules.

According to some embodiments of the present invention further comprising the step of: scoring alignment and position by evaluating elements are alignments and placed based on the design rules within the composition and within the cluster.

According to some embodiments of the present invention the dense element representation refers to how elements are drawn, using bounding boxes or dilated text to maximize visibility in low resolutions, wherein the goal is to maximize the overlap score between the heat map and the elements while maintaining the original shape and structure of the elements.

According to some embodiments of the present invention the visual elements comprise at least one of: text, logo, icon, image, or video, to be placed on background images and video frames.

According to some embodiments of the present invention the heat maps that represent the distribution regions where groups of visual elements can be placed within the image, providing a detailed visual guide for determining the most appropriate areas for visual elements integration.

According to some embodiments of the present invention the attention maps are used to identify negative spaces within media, ensuring that critical areas are not obscured by visual elements.

The present invention provides a system for integrating visual elements in image and video, implemented by one or more processors operatively coupled to a non-transitory computer readable storage device, on which are stored modules of instruction code, comprising:
an Image Processing Extracting Text Module configured for processing images, detecting and extracting text from them;
a Heat Map AI Model configured to produce heat maps which detect positive areas for placing visual elements based on input training images and video frames;
an Attention Maps AI Model configured to detect negative areas of important regions of the image indicating where not to place the visual element;
a Post Processing and Scoring Module configured to take the heat and attention maps, performs additional processing, and generates a Distance Map, wherein the module is further configured for scoring or ranking the different layout permutations;
a Layout Permutation generation module configured to generate different permutations of layout designs to optimize the placement of visual elements in images; and
Image Design Rules comprising a set of guidelines for arranging the layout of visual elements.

According to some embodiments of the present invention the system comprising a Clustering Algorithm configured to cluster data points into groups, wherein the algorithm computes clusters derived from the heat maps and attention maps.

According to some embodiments of the present invention the system further comprising an Internal Image Source which supplies images and/or video frames which have embedded known design of visual elements for training the AI models.

According to some embodiments of the present invention the system further comprising an External Image Sources which provides additional external images and visual/multimedia elements to be placed within the system, including synthetically generated images with visual/multimedia elements using various AI image generation models.

According to some embodiments of the present invention the system further comprising a CRM (confidence refinement module) is developed for detail refinement, where it utilizes its first prediction as a clue and generates features to improve its second prediction, wherein in between each stage, pixel shuffle is applied to avoid the loss of details caused by interpolation methods

According to some embodiments of the present invention the scoring module uses layout permutations that conform to design rules to algorithmically select the best placement and shape of the visual elements and score the results using the heat map and attention maps.

### BRIEF DESCRIPTION OF THE SCHEMATICS

The present invention will be more readily understood from the detailed description of embodiments thereof made in conjunction with the accompanying drawings of which:

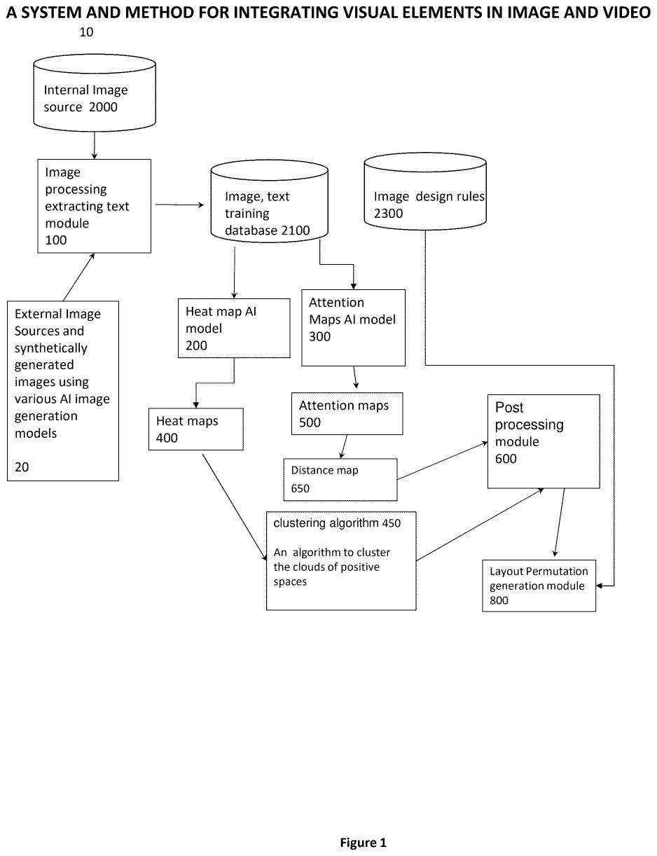

FIG. 1 is a block diagram, depicting the components and the environment of the text image synergy system, according to some embodiments of the invention.

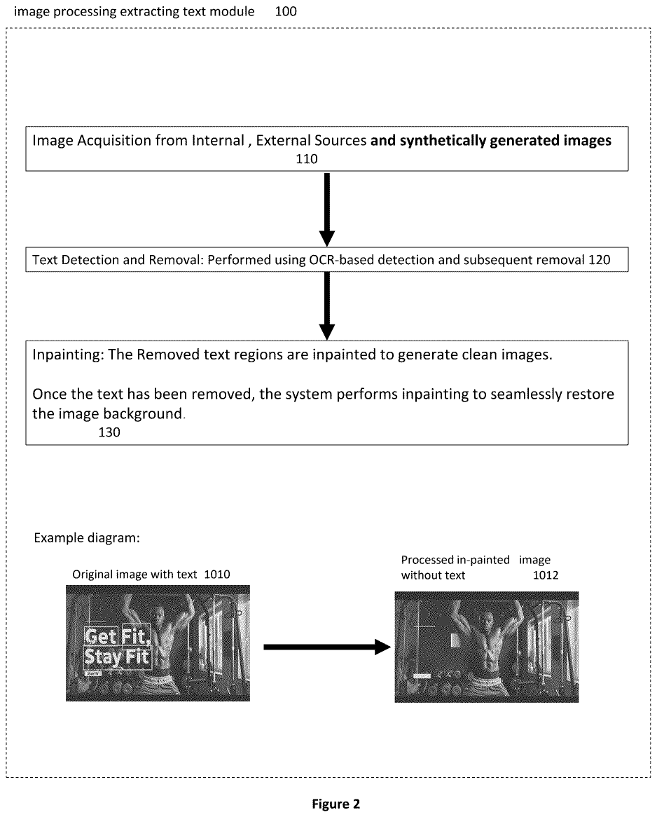

FIG. 2 is a flowchart depicting image collection and synthetic image generation module. Including the OCR-based text removal and inpainting modules. 100, according to some embodiments of the invention.

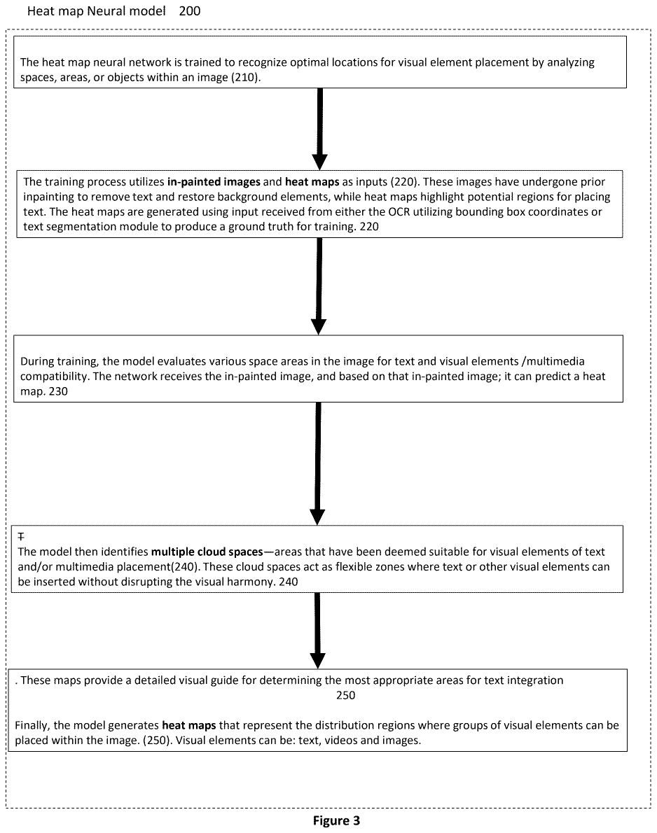

FIG. 3 is a flowchart depicting a heat map neural network for detecting the positive text placement areas, according to some embodiments of the invention.

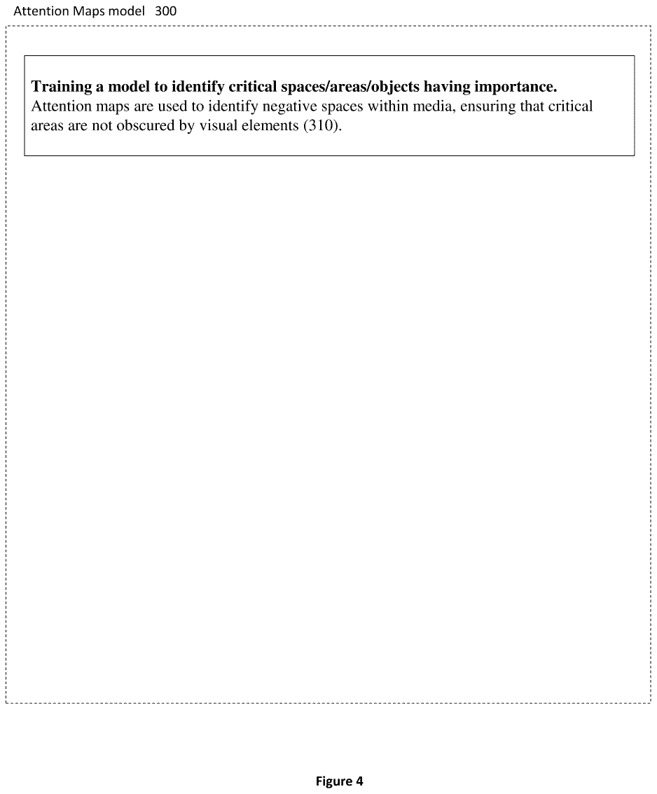

FIG. 4 presents a flowchart, attention maps neural model according to some embodiments of the invention.

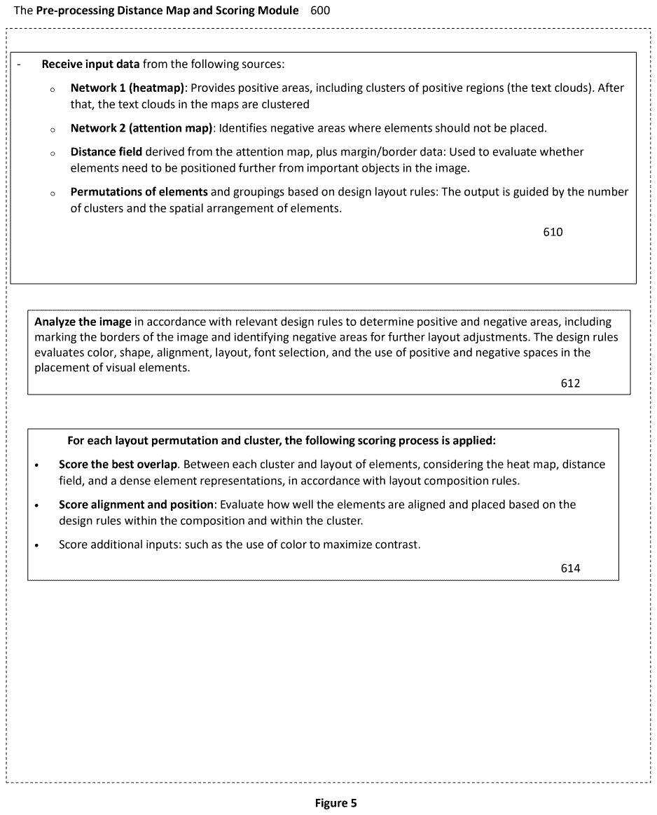

FIG. 5 presents a flowchart, pre-processing distance map creation and layout scoring module, according to some embodiments of the invention.

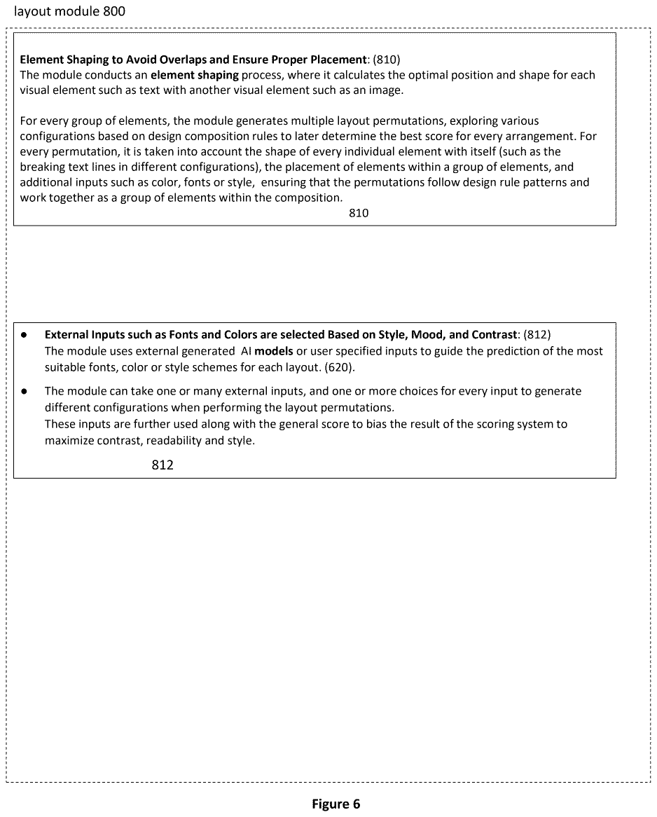

FIG. 6 presents a flowchart layout module, according to some embodiments of the invention.

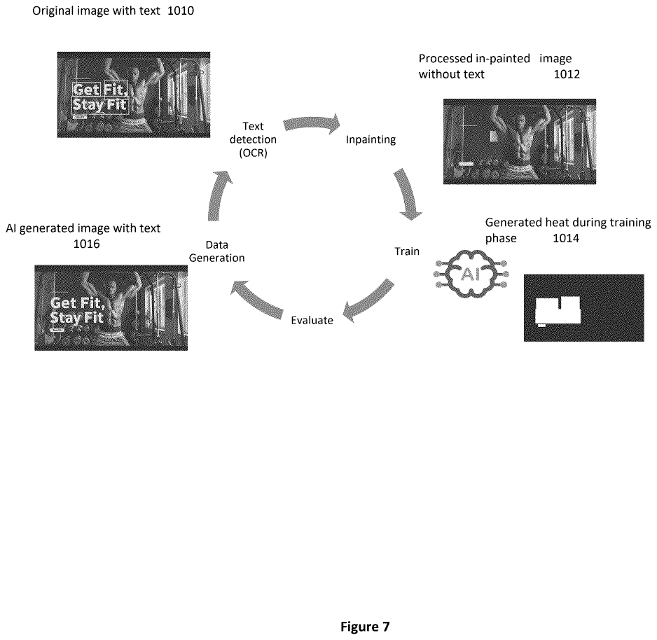

FIG. 7 presents an example of the complete image processing, data generation, data preparation, training and evaluation cycle, according to some embodiments of the invention.

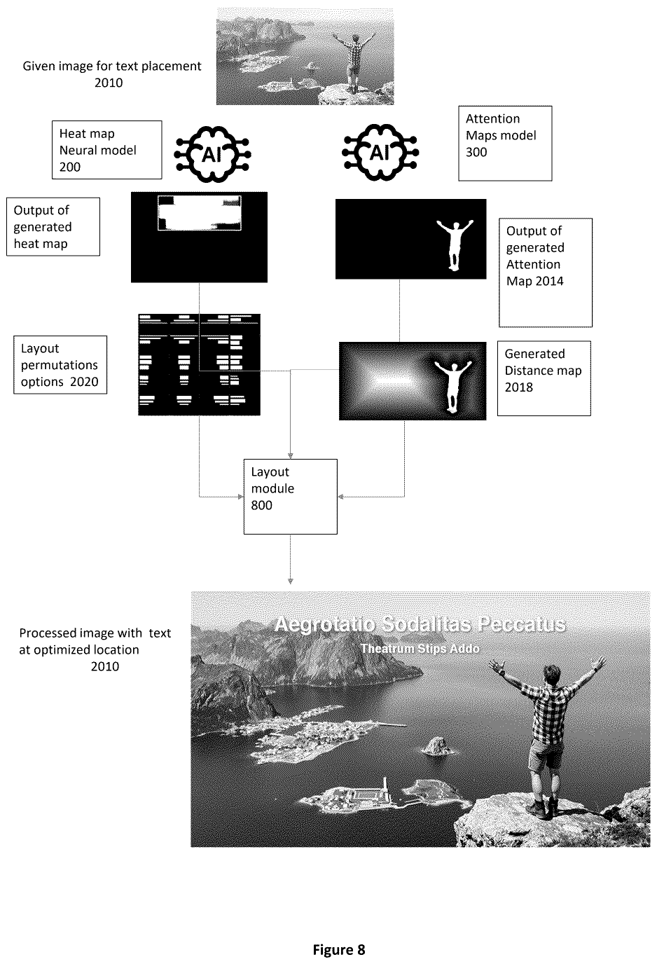

FIG. 8 presents an example heat map, attention map and distance map processing cycle, according to some embodiments of the invention.

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention describes the integration of various visual elements in the context of a composition. The present invention can be applied and implemented to any media type. The below description relates mainly to a visual element of text integrated with visual element of an image, however it can be implemented to other types of visual elements, such as logo, icon, image placement on both (background) images and videos frames.

FIG. 1 is a block diagram, depicting the components and the environment of the visual elements integration system, according to some embodiments of the invention. (10)

This visual element integration system is comprised of:
An Image Processing Extracting Text Module (100): configured for processing images, detecting and extracting text from them.
Internal Image Source (2000) which supplies images and/or video frames which have embedded known design of visual elements (like text, icons, logos) for training the AI models.
External Image Sources (20): which provides additional external images and visual/multimedia elements to be placed within the system. Plus, synthetically generated images with visual/multimedia elements, using various AI image generation models.
Heat Map AI Model (200), configured to produce heat maps which detect positive areas for placing visual elements based on input training images and video frames.
Attention Maps AI Model (300): detects negative areas of important regions of the image indicating where not to place the visual element such as the text or multimedia.
Heat Maps (400) and Attention Maps (500): These maps are outputs from the AI models and feed into the Post Processing Module (600) for further refinement.

### Post Processing and Scoring Module (600)

This module takes the heat and attention maps, performs additional processing, and generates a Distance Map (650) and Clustering Algorithm (450). This model is further configured for scoring or ranking the different layout permutation.
Layout Permutation generation module (800), configured to generate different permutations of layout designs, which could be used to optimize the placement of visual elements in images.
Image Design Rules (2300) comprise a set of guidelines for arranging the layout of visual elements.
Clustering Algorithm: configured to cluster data points into groups. This algorithm computes clusters derived from the heat maps and attention maps.

### Flow Summary

Images are supplied by internal and external sources and processed by the image processing multimedia and text Extraction Text Module (100). After text and multimedia extraction, the empty spaces are inpainted, using various inpainting algorithms.

The processed data flows into AI models for generating heat maps (positive spaces) and attention maps (negative spaces).

These maps are refined through post-processing, which generates additional outputs like distance maps and clusters.

The processed data then guides the layout of text and video, applying video design rules to ensure a coherent and visually appealing output.

The scoring module uses layout permutations (that conform to design rules) to algorithmically select the best placement and shape of the visual elements and score the results using the aforementioned heat map and attention maps, refining the design further.

The overall goal of the system is to generate visually appealing compositions for images and videos frames. Using machine learning models, deep learning models and classical computer vision techniques. Compositions are generated layouts given a background image or frame, and visual elements/multimedia input (like text, icons, logos and images).

FIG. 2 is a flowchart depicting image processing extracting text module (100), according to some embodiments of the invention.

The Image Processing and Text Extraction Module (100) executes a sequence of operations aimed at extracting textual information from images while preserving the visual integrity of the source. The process involves the following key steps:
1. Image Acquisition from Internal and External Sources (110):
   The system scans images and video frames obtained from both internal databases, external inputs, and synthetically generated images. This step ensures a diverse range of image sources for processing, catering to different use cases and quality levels.
2. Text Detection and Removal (120):
   The module employs advanced Optical Character Recognition (OCR) techniques to accurately detect text regions within the image. Following detection, the text is removed to prepare the image for further refinement.
   Optionally using character segmentation to remove only the text, instead of removing entire bounding boxes (generated by OCR).
3. Inpainting for Background Restoration (130):
   Once the text has been removed, the system performs inpainting to seamlessly restore the image background. This process involves analyzing the surrounding areas to identify the most relevant textures and patterns, ensuring that the edited region matches the natural appearance of the image.
   The inpainting is carried out using multiple random inpainting neural networks. This diversity in networks ensures that the system does not adopt a fixed inpainting style, which could lead to overfitting or repetition. Instead, it adapts dynamically, based on the unique features of each image.
   Neural networks utilize global and local features from the surrounding areas of the removed text to intelligently fill the gaps, maintaining both fine details and the overall visual consistency of the image.

FIG. 3 is a flowchart depicting Heat map Neural model according to some embodiments of the invention.

The Heat Map Neural Model (200) executes a set of operations designed to optimize text visual element placement in images and video frames by identifying the most suitable regions. The following steps highlight its core functionalities:

The heat map neural network is trained to recognize optimal locations for visual element placement by analyzing spaces, areas, or objects within an image. It identifies regions that are positively suited for placing the visual elements, ensuring that the elements integrate seamlessly with the image (210).
The model is adept at selecting positive spaces where visual elements can be placed without disrupting the visual flow.

The training process utilizes in-painted images and heat maps as inputs (220). These images have undergone prior inpainting to remove text and restore background elements, while heat maps highlight potential regions for placing text. The heat maps are generated using input received from either the OCR utilizing bounding box coordinates or text segmentation module to produce a ground truth for training.

During training, the model evaluates various space areas in the image for text and visual elements/multimedia compatibility. (230) The network receives an in-painted image and based on that in-painted image; it can predict a heat map. During the training the predicted heat map is compared with the ground truth heat map. The comparison is done using various loss functions. Based on the loss, the network receives feedback. Based on the feedback, it learns how to generate better predictions of positive area spaces.

The model then identifies multiple cloud spaces—areas that have been deemed suitable for visual elements of text and/or multimedia placement (240). These cloud spaces act as flexible zones where text or other visual elements can be inserted without disrupting the visual harmony.

Finally, the model generates heat maps that represent the distribution regions where groups of visual elements can be placed within the image. These maps provide a detailed visual guide for determining the most appropriate areas for visual elements of text and/or multimedia integration (250). Visual elements can be text, videos and images.

FIG. 4 presents a flowchart, Attention Maps model according to some embodiments of the invention.

Attention Maps training Model (300), applies at least one of the following steps:
Training a model to identify critical spaces/areas/objects having importance. Attention maps are used to identify negative spaces within media, ensuring that critical areas are not obscured by visual elements (310).

It's a partially Transformer-based network equipped with a global and local context branch for better structural integrity and local details in prediction.
Network architecture for the attention map generator:
   Encoder (from various pretrained encoders) features are fed into the global context branch for patch-wise classification to obtain a low-resolution global context map. The map is further fused in CRM (confidence refinement module) to locate the salient object.
   A CRM (confidence refinement module) is developed for detail refinement, where it utilizes its first prediction as a clue and generates features to improve its second prediction. In between each stage, pixel shuffle is applied to avoid the loss of details caused by interpolation methods.

FIG. 5 presents a flowchart, Pre-processing of Distance map and scoring module a, according to some embodiments of the invention.

The Pre-processing Distance Map and Scoring Module performs the following steps:
Receive input data from the following sources: (612)
Network 1 (heat map): Provides positive areas where visual elements are likely to be placed.
Network 2 (attention map): Identifies important elements in the composition defined as negative areas where elements should not be placed.

Distance field: Derived from the attention map, a signed distance field is generated to evaluate whether elements need to be positioned further from important objects in the image and to identify the areas where the placement of the elements would create the best balance within the composition.

Using distance fields to score placement of visual elements, wherein the placement optimizes placement by minimizing obscuring important parts of the image or video frame while maintaining maximum distance from all important parts

A synthetic border is also introduced when computing the distance field to guide the elements away from the borders/margins of the composition.
Clustering: Using the heat map (positive areas) and attention map and distance field (negative areas), a clustering algorithm is performed to evaluate one or many areas where the placement of elements would yield the most positive results. Scoring in accordance with relevant design rules to determine and score positive and negative areas (derived from the heat map, attention map and distance field), marking the borders of the image and identifying areas for further layout adjustments. The design rules evaluate features such as color, shape, alignment, layout, font selection, and the use of positive and negative spaces in the placement of visual elements. (610);

Permutations of elements and groupings based on layout design rules: The output is guided by the number of clusters and the spatial arrangement of elements, layouts consisting in groups of elements are generated using The Layout Module (800).

For each layout permutation and cluster, the following scoring process is applied: (614)
Score the best overlap between each cluster and layout of elements, considering the heat map, distance field, and a dense element representation, in accordance with layout composition rules.
Score alignment and position: Evaluate how well the elements are aligned and placed based on the design rules within the composition and within the cluster.
Score additional inputs: such as the use of color to maximize contrast.

Distance field depth measures the distance for every pixel from the nearest pixel in the attention map or the image margins (borders). For each pixel, a deeper score indicates that the pixel is further away from key objects, and highest scores are set for the emptiest areas. This scoring helps to determine how close or far the predicted elements are from important areas, ensuring that they occupy more available space in the image while keeping a safe distance from critical regions.

Dense element representation refers to how elements are drawn, using bounding boxes or dilated text to maximize visibility in low resolutions. The goal is to maximize the overlap score between the heat map and the elements while maintaining the original shape and structure of the elements.

FIG. 6 presents a flowchart, layout module, according to some embodiments of the invention

The Layout Module (800) executes a series of algorithmic operations to ensure that visual elements (one visual element containing text or an image) are harmoniously arranged within a visual composition. The module applies at least one of the following steps to achieve optimal layout and aesthetic alignment:
Element Shaping to Avoid Overlaps and Ensure Proper Placement: (810)
The module conducts an element shaping process, where it calculates the optimal position and shape for each visual element such as text with another visual element such as an image. This process aims to prevent overlaps and keep proper distance between the elements, which could lead to clutter or obscuring important visual content.
For every group of elements, the module generates multiple layout permutations, exploring various configurations based on design composition rules to later determine the best score for every arrangement. For every permutation, it is taken into account the shape of every individual element with itself (such as the breaking text lines in different configurations), the placement of elements within a group of elements, and additional inputs such as color, fonts or style, ensuring that the permutations follow design rule patterns and work together as a group of elements within the composition.
External Inputs such as Fonts and Colors are selected Based on Style, Mood, and Contrast: (812)
The module uses external generated AI models or user specified inputs to guide the prediction of the most suitable fonts, color or style schemes for each layout. These predictions are based on factors such as the style, mood, and contrast of the image or video. Unless explicitly supplied by the user, a generative AI analyzes the overall visual tone of the media to be produced and selects font types and colors that complement the intended message and aesthetic. This ensures that the text not only fits within the visual space but also aligns with the emotional and contextual requirements of the content (620).
The module can take one or many external inputs, and one or more choices for every input to generate different configurations when performing the layout permutations.
These inputs are further used along with the general score to bias the result of the scoring system to maximize contrast, readability and style.

FIG. 7 presents an example of an image processing cycle for training, according to some embodiments of the invention.

The image processing cycle starts with the original image with text (1010), at first phase the text is detected and extracted by OCR or text segmentation. Inpainting techniques are then used to produce an in-painted image without text (1012).

During the AI model training heat maps are generated (1014) representing positive areas for placing visual elements. The training process ends with heat maps containing positive area distributions for placing the visual elements (1016)

This flow diagram represents the process starting from an original image containing text and progressing through the following stages:
1. OCR-Based Text Detection and Inpainting: The text is detected using OCR, and the detected text is removed through inpainting techniques to create modified images.
2. Model Training and Evaluation: These inpainted images are used to train a model, which is then evaluated based on a permutation scoring system.
3. Analysis and Dataset Refinement: The evaluation highlights the types of images where the model performs weakly. Using this information, similar types of images are generated using AI-based tools (such as Stable Diffusion).
4. Augmentation and Retraining: These newly generated images are added to the dataset, enriching it with challenging samples to further improve model performance through additional training.

The image processing cycle begins with the original image with text (1010). In the initial phase, text within the image is detected and extracted using Optical Character Recognition (OCR). After text extraction, inpainting techniques are applied to fill in the areas where the text was removed, producing a processed in-painted image without text (1012). This phase ensures the background is seamlessly restored while preparing the image for further processing.

During the subsequent AI model training phase, heat maps are generated (1014), representing the positive areas in the image where the text can be optimally placed. These heat maps help guide the AI model in identifying suitable locations for text placement without obstructing important visual content. The training process culminates in the creation of a final result, which is an AI-generated image with text (1016). This image incorporates the placement suggestions derived from the heat maps, ensuring an aesthetically pleasing and effective layout.
FIG. 8 presents an example of a processing flow for placing a visual element of text in an image by generating heat map, attention map and distance map, according to some embodiments of the invention.
The process starts with an input image (2010). This image gets processed by two neural networks:
   i. one for analyzing positive text placement areas (the heat map model (200))
   ii. one for analyzing the negative text placement areas (the attention map model (300))
From the output of the attention map model a distance field map is generated (2018). Next, layout permutations (2020) are generated based on the distance map (2018) and the output of the heat map model (200). The layout permutations are scored according to algorithmically defined design rules. The permutation with the highest score will be taken for the placement of the visual elements (800).

This flow diagram illustrates the process of placing a visual element of text within an image by leveraging a heat map, attention map, and distance map, according to certain embodiments of the invention.

The processing begins with a given image for text placement (2010). This image is analyzed by the system using the aforementioned heat map (200) and attention map (300).
The Heat Map AI Neural Model (200) generates a heat map that identifies positive areas suitable for text placement.
The Attention Maps Model (300) produces an Attention Map (2014) that highlights negative areas where text should not be placed.

As part of this postprocessing stage, a generated distance map (2018) is created, to provide spatial relationships within the image. These outputs are then used to prepare various element layout permutations (2020), allowing for the exploration of different text placement arrangements. In the final stage, the permutations are scored by the scoring module and then the optimal layout is selected, resulting in a processed image with text at the optimized location (2010).

This process combines the outputs from the heat map and attention map, which offer insights into positive and negative text placement zones, along with distance map calculations. The goal is to generate an aesthetically pleasing and contextually appropriate layout. The system evaluates multiple permutations of text placement before finalizing the processed image, ensuring that the text is placed in the most effective and visually harmonious location.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other but may be used alone or combined in other combinations. The excision of any disclosed element of the invention is explicitly contemplated as within the scope of the invention.

The words used in this specification to describe the invention, and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless, changes and modifications, which do not depart from the teachings of the present invention, will be evident to those skilled in the art. Such changes and modifications are deemed to come within the purview of the present invention and the appended claims.

1. A method for integrating visual elements in image and video, implemented by one or more processors operatively coupled to a non-transitory computer readable storage device, on which are stored modules of instruction code that when executed cause the one or more processors to perform the steps of:
producing a heat map for scoring positive placement areas for at least one first visual element within the context of a second visual element, wherein the visual element is at least one of image or video frame;
producing an attention map for scoring negative placement areas for at least one first visual element within the context of a second visual element, wherein the attention map identifies important regions of the image indicating where not to place the visual element;
using distance fields to score placement of visual elements, wherein the placement optimization is achieved by minimizing obscuring important parts of the image or video frame while maintaining maximum distance from all important parts; wherein the distance field depth measures the distance for every pixel from the nearest pixel in the attention map or the image margins, wherein for each pixel, a deeper score indicates that the pixel is further away from key objects, and highest scores are set for the emptiest areas;
scoring in accordance with relevant design rules to determine and score positive and negative areas derived from the heat map, attention map and distance field;
generating multiple layout permutations of the elements, which are then evaluated against all the scoring criteria to select the best possible placement, layout and style; and
wherein the heat map and the attention map are produced automatically using training data by AI models.

2. The method of claim 1, wherein the distance field is derived from the attention map, to evaluate whether elements need to be positioned further from important objects in the image and to identify the areas where the placement of the elements would create the best balance within the composition.

3. The method of claim 1, further comprising the step of clustering: using the heat map (positive areas) and attention map and distance field (negative areas), wherein a clustering algorithm is performed to evaluate one or many areas where the placement of elements would yield the most positive results.

4. The method of claim 1, wherein the heat map neural network is trained to recognize optimal locations for visual element placement by analyzing spaces, areas, or objects within an image, and identifies regions that are positively suited for placing the visual elements, ensuring that the elements integrate seamlessly with the image.

5. The method of claim 1, wherein the training process utilizes in-painted images and heat maps as inputs, wherein the heat maps are generated using input received from either OCR utilizing bounding box coordinates or text segmentation module to produce a ground truth for training.

6. The method of claim 1, wherein the design rules evaluate features including at least one of: color, shape, alignment, layout, font selection, and the use of positive and negative spaces in the placement of visual elements.

7. The method of claim 1, wherein for each layout permutation and cluster, a scoring process is applied comprising: scoring the best overlap between each cluster and layout of elements, considering the heat map, distance field, and a dense element representation, in accordance with layout composition rules.

8. The method of claim 1, further comprising the step of: scoring alignment and position by evaluating elements are alignments and placed based on the design rules within the composition and within the cluster.

9. The method of claim 7, wherein dense element representation refers to how elements are drawn, using bounding boxes or dilated text to maximize visibility in low resolutions, wherein the goal is to maximize the overlap score between the heat map and the elements while maintaining the original shape and structure of the elements.

10. The method of claim 1, wherein the visual elements comprise at least one of: text, logo, icon, image, or video, to be placed on background images and video frames.

11. The method of claim 1, wherein the heat maps that represent the distribution regions where groups of visual elements can be placed within the image, providing a detailed visual guide for determining the most appropriate areas for visual elements integration.

12. The method of claim 1, wherein the attention maps are used to identify negative spaces within media, ensuring that critical areas are not obscured by visual elements.

13. A system for integrating visual elements in image and video, implemented by one or more processors operatively coupled to a non-transitory computer readable storage device, on which are stored modules of instruction code, comprising:
an Image Processing Extracting Text Module configured for processing images, detecting and extracting text from them;
a Heat Map AI Model configured to produce heat maps which detect positive areas for placing visual elements based on input training images and video frames;
an Attention Maps AI Model configured to detect negative areas of important regions of the image indicating where not to place the visual element;
a Post Processing and Scoring Module configured to take the heat and attention maps, performs additional processing, and generates a Distance Map, wherein the module is further configured for scoring or ranking the different layout permutations;
a Layout Permutation generation module configured to generate different permutations of layout designs to optimize the placement of visual elements in images; and
Image Design Rules comprising a set of guidelines for arranging the layout of visual elements.

14. The system of claim 13, further comprising a Clustering Algorithm configured to cluster data points into groups, wherein the algorithm computes clusters derived from the heat maps and attention maps.

15. The system of claim 13, further comprising an Internal Image Source which supplies images and/or video frames which have embedded known design of visual elements for training the AI models.

16. The system of claim 13, further comprising an External Image Sources which provides additional external images and visual/multimedia elements to be placed within the system, including synthetically generated images with visual/multimedia elements using various AI image generation models.

17. The system of claim 13, further comprising a CRM (confidence refinement module) is developed for detail refinement, where it utilizes its first prediction as a clue and generates features to improve its second prediction, wherein in between each stage, pixel shuffle is applied to avoid the loss of details caused by interpolation methods

18. The system of claim 13, wherein the scoring module uses layout permutations that conform to design rules to algorithmically select the best placement and shape of the visual elements and score the results using the heat map and attention maps.
